(19) United States
(12) Patent Application Publication
(10) Pub. No.: US 2009/0211166 A1
(43) Pub. Date: Aug. 27, 2009

(54) Seal arrangement on a vertical frame profile of a door wing

(75) Inventor: Christian Mayer, Unterthuerheim (DE)

Correspondence Address: COHEN, PONTANI, LIEBERMAN & PAVANE LLP, 551 FIFTH AVENUE, SUITE 1210, NEW YORK, NY, 10176, US

(73) Assignee: Dorma GmbH + Co. KG, Ennepetal (DE)

(21) Appl. No.: 11/658,429

(22) PCT Filed: Jul. 13, 2005
(86) PCT No.: PCT/EP05/07590

§ 371 Date: Jan. 26, 2007

(30) Foreign Application Priority Data
Jul. 27, 2004 (DE) 10 2004 036 309.9

(51) Int. Cl. E06B 7/22

(52) U.S. Cl. 49/498.1

(57) ABSTRACT

The invention relates to a seal, which is disposed at a vertical frame profile of a stationary door leaf or of a movable door leaf and has a sealing profile protruding from the frame profile and a deformation chamber extending in longitudinal direction of the sealing profile. The invention concentrates on the fact that a part of the sealing profile protruding from the front side of the frame profile in cross-section forms the portion (T) of an ellipse or substantially of an ellipse, the minor axis (N) of the ellipse intersecting the wall of the sealing profile outside the frame profile.

The invention relates to a seal, which is disposed at a vertical frame profile of a stationary door leaf or of a movable door leaf and has an elastic sealing profile protruding from the front side of the frame profile, which sealing profile has a web abutting the frame profile and being connected to the frame profile, and a deformation chamber extending in longitudinal direction of the sealing profile and being delimited by the web.

Seals of the species mentioned above are used for example when designing smoke-tight doors which guarantee sterile work spaces and generally avoid draught air. In this case, glass leaf doors are used increasingly, the glass panes thereof being clamped in a frame profile. In this case, the seal between two movable leaves or between a stationary leaf and a movable leaf must be formed such that it develops its optimum sealing effect at a given minimum distance, i.e. a given gap between two adjacent leaves in their closing position. This effect needs to be guaranteed even with front sides, which are not absolutely aligned one in front of the other, i.e. horizontally offset in lateral direction, or with adjacent leaves' front sides, which are restrictedly angled towards each other. U.S. Pat. No. 2,611,937 discloses a sealing device of this species generally designed for rail-bound vehicles. In this case, an elastic sealing element, having sealing lips and being approximately O-shaped in cross-section, is disposed at the front side of a movable door leaf, and a rigid flange-shaped sealing element engaging between the sealing lips is disposed at the front side of the stationary door leaf, intended to thereby achieve a triple sealing with the door being closed. This is a structural complicated double sealing, consisting of an elastic and a firm sealing part. The individual sealing elements are connected through screw connections to the door leaf by means of fittings, which in a U-shape, overlap the front side of the door leaf, i.e. they are not suitable to be used for the sealing of glass doors. Moreover, the proper functioning is only guaranteed with an aligned disposition of the door leaves.

It is an object of the invention to improve a seal species in that reliable sealing properties are guaranteed with a simple structural embodiment, even with front sides of adjacent door leaves, which are restrictedly offset in a horizontal plane towards each other or with door leaves, which are restrictedly angled towards each other. The seal is intended to be universally applicable for door leaves, as long as they are provided with a frame profile, i.e. especially with stationary or movable glass leaves, on condition that, in the closed position, a generally defined gap is given between the leaves that are to be sealed in relation to each other.

The invention solves the given problem with the teaching according to claim 1.

By means of an elliptically or generally elliptically embodied portion of the walling of a sealing profile, which portion protrudes from the front side of a frame profile, in conjunction with the feature that the minor axis of the ellipse intersects the walling of the sealing profile outside the frame profile, that means intersects it in the area of the gap between adjacent leaves in the closed position, reliable sealing properties are provided even in the case of door leaves being restrictedly angled towards each other. This results from the fact that—a gap normally used in the practice and generally defined between the adjacent door leaves being a prerequisite—an ellipse walling with a falling curve on the one side is compensated for by an ellipse walling with a rising curve on the other side. Webs reinforcing the hollow space eliminate too much yielding of the walling of the sealing profile and simultaneously stabilize the sealing profile during the insertion process into the adjacent door leaf.

Further preferred embodiments of the invention are set forth in the dependent claims.

The webs, supporting the walling of the sealing profile, on either side of the major axis of the ellipse, abut a walling of the deformation chamber at the other end such that forces acting upon the walling of the sealing profile can be introduced into the deformation chamber via the webs and can be absorbed therein.

In a further embodiment of the invention, devices for a connection to the frame profile, which devices preferably consist of strip-like projections, are disposed at the web abutting the frame profile, and which, as an integral part of the web, rearward engage complementary projections of the frame profile in a hook-like manner. The above embodiment of the sealing profile's connection to the frame profile guarantees, on the one side, a tension and compression resistant connection between the sealing profile and the frame profile and, on the other side, allows for an easy exchange of the seal in the event of wearing, because any screw connections are eliminated.

In the following, the invention will be explained in more detail, reference being made to an exemplary embodiment, in which:

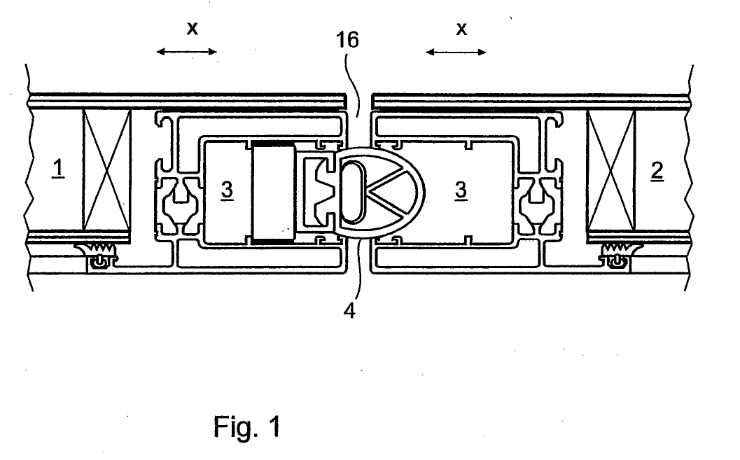

FIG. 1 shows a horizontal section through a partitioning wall consisting of glass leaf panels;

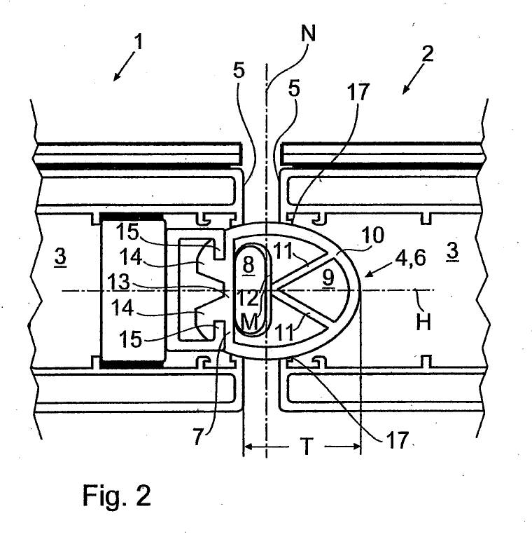

FIG. 2 shows, compared to FIG. 1, an enlarged illustration of the seal between two adjacent leaves or between a leaf and a stationary wall; and

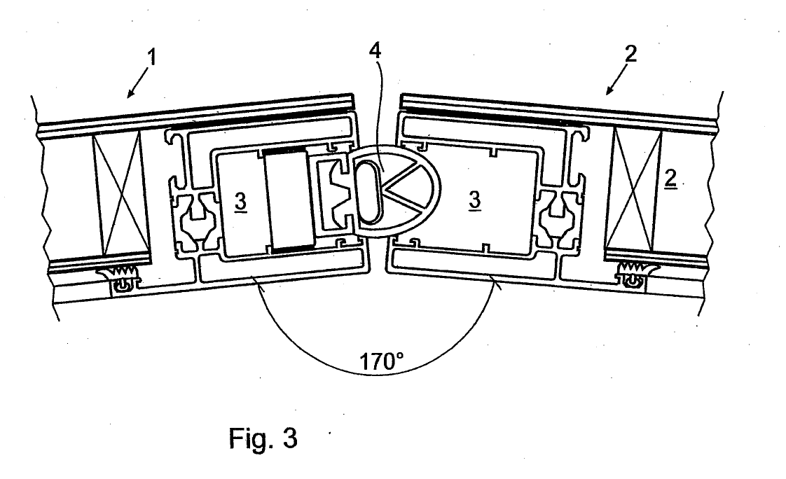

FIG. 3 shows a detail according to FIG. 1 with leaves restrictedly angled towards each other.

In the illustrated exemplary embodiment, a first door leaf is referenced by 1 and a second door leaf by 2. The door leaves 1 and 2 are displaceable in direction X. Both door leaves have vertical frame profiles 3, which, in the closed position, are located in front of each other while forming a gap 16. In the exemplary embodiment, a seal 4 is connected to the first leaf 1; as the frame profiles 3 are mirror-inverted, the seal 4, as an option, can be disposed at the second door leaf 3 as well or at any other of the leaves or at a stationary partitioning wall.

As FIG. 2 reveals, the seal 4 with a proper sealing profile 6 protrudes from a front side 5 of the frame profile 3 by a portion of the sealing profile 6 identified by T. A walling 10 of the sealing profile 6 follows the shape of a portion of an ellipse and, according to FIG. 2, in the area of a connection to the stationary door leaf 1, merges into a web 7, which, with integrally conformed projections 14, rearward engages complementary projections 15 of the frame profile 3. Furthermore, a deformation chamber 8 is provided extending in longitudinal direction of the seal 4. Two webs 11, extending on either side of the major axis H of a walling 10 of the sealing profile 6 into the direction of the deformation chamber 8, reinforce a hollow space, identified by 9, of the sealing profile 6. The webs 11 are connected to a walling 12 of the deformation chamber 8 such that they intersect each other almost in the centre M of the ellipse, i.e. in the intersection point of the major axis H and the minor axis N. The walling opposite the walling 12 of the deformation chamber 8 is formed by a portion 13 of the web 7.

FIG. 2 clearly shows that the elliptical or generally elliptical shape of the sealing profile 6 is designed such that the minor axis N extends in the area of the gap 16 between the adjacent door leaves 1 and 2. This means that the movable door leaf 2, in FIG. 2 on the right side of the illustration, during a pivoting movement in relation to the stationary door leaf 1 (cf. FIG. 3), moves with the sealing edges 17 of the frame profile 3 along the curve path of the walling 10 of the sealing profile 6, such that the upper sealing edge 17 in the plane of the illustration follows a falling curve path and the lower sealing edge 17 in the plane of the illustration follows a rising curve path, resulting in sealing properties which are guaranteed even with leaves restrictedly angled towards each other. In FIG. 3 the exemplary angle is indicated with 170°.

### LIST OF REFERENCES

1 first door leaf
2 second door leaf
3 frame profile
4 seal
5 front side
6 sealing profile
7 web
8 deformation chamber
9 hollow space
10 walling
11 webs
12 walling
13 portion
14 projections
15 complementary projections
16 gap
17 sealing edges
T portion
N minor axis
H major axis
M centre
X direction of arrow

1.-5. (canceled)

6. A seal disposed in a vertical frame profile of one of a stationary door leaf, a movable door leaf, or a stationary wall, said seal comprising an elastic sealing profile extending longitudinally along a longitudinal axis of the frame profile and protruding from a front side of the frame profile, the sealing profile being defined by a first web abutting and being connected to the frame profile and a wall which merges into said web and encloses a longitudinal hollow space, said wall having a cross-sectional shape forming a portion of an ellipse arranged so that a minor axis of the ellipse intersects the wall in an area that is outside of the frame profile and in the hollow space, said sealing profile further including a deformation chamber extending longitudinally through the sealing profile and delimited toward the frame profile by said first web, and at least two second webs arranged on either side of the major axis of the ellipse supporting the wall, said at least two second webs intersecting approximately at a center of the ellipse.

7. The seal of claim 6, further comprising a second wall delimiting at least a portion of said deformation chamber, wherein said second webs are supported at said second wall.

8. The seal of claim 7, wherein a portion of said first web that abuts the frame profile forms a portion of said second wall defining said deformation profile.

9. The seal of claim 6, wherein said first web includes profiles complementary to the frame profile and arranged for connection the seal to the frame profile.

10. The seal of claim 9, wherein said complementary profiles includes strip-shaped projections which interlock and engage projections on the frame profile.

11. The seal of claim 10, wherein said strip-shaped projections form a hook-shaped projections which engage rear-facing surfaces of said frame profile.
